(19) United States
(12) Patent Application Publication
(10) Pub. No.: US 2024/0284477 A1
(43) Pub. Date: Aug. 22, 2024

(54) Method And Apparatus For Physical Downlink Control Channel Monitoring And Scheduled Cells Combination For Multi-Cell Scheduling

(71) Applicant: MediaTek Inc., Hsinchu City (TW)

(72) Inventor: Chi-Hsuan Hsieh, Hsinchu City (TW)

(21) Appl. No.: 18/420,825

(22) Filed: Jan. 24, 2024

Related U.S. Application Data
(60) Provisional application No. 63/485,269, filed on Feb. 16, 2023.

(51) Int. Cl. H04W 72/232; H04W 72/1273

(52) U.S. Cl. CPC H04W 72/232; H04W 72/1273

(57) ABSTRACT

Various solutions for adaptations of physical downlink control channel (PDCCH) monitoring and scheduled cells combination for multi-cell scheduling with a single downlink control information (DCI) are described. An apparatus may receive a configuration of one or more search spaces for a DCI indicating a scheduling on a first cell in a second cell. The apparatus may detect the DCI indicating the scheduling on the first cell in the second cell according to the configuration. The apparatus may determine not to monitor PDCCH candidates on an active downlink (DL) bandwidth part (BWP) of the first cell.

### CROSS REFERENCE TO RELATED PATENT APPLICATION(S)

The present disclosure is part of a non-provisional application claiming the priority benefit of U.S. Patent Application No. 63/485,269, filed 16 Feb. 2023, the content of which herein being incorporated by reference in its entirety.

### TECHNICAL FIELD

The present disclosure is generally related to mobile communications and, more particularly, to physical downlink control channel (PDCCH) monitoring and scheduled cells combination for multi-cell scheduling.

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using a plurality of cells forming a radio access network. The BS may support the operations of the plurality of cells, and each cell may be operable to provide services to at least one user equipment (UE) within its radio coverage. Specifically, each cell may provide services to serve one or more UEs within its radio coverage based on at least one downlink control information (DCI), where a radio coverage of one cell may overlap with another radio coverage of other cell(s). In one example, each cell may schedule a downlink/uplink (DL/UL) resource to one UE within its radio coverage by one DCI for performing a DL/UL transmission. If the UE can support more than one cells (e.g., in dual connectivity/carrier aggregation), the UE may receive more than one DCI for scheduling DL/UL transmissions with more than one cells. As that, the network and the BS have to configure a plurality of DCIs corresponding to the plurality of cells respectively to the UE so as to schedule resources for the DL/UL transmissions between the UE and the cells, which may lack of transmission efficiency and waste available network resources. In addition, there is a bit number limit for decoding the DCI if one specific decoding technique (e.g., polar decoding technique) is utilized by the UE. That is, the field number/size of the DCI should comply with a bit-limit rule/regulation.

Accordingly, how to improve multi-cell scheduling with a single DCI becomes an important issue for the newly developed wireless communication network. In particular, the issues of DCI aggregation for multi-cell scheduling further involve adaptations of physical downlink control channel (PDCCH) monitoring for UE power saving and scheduled cells combination. Therefore, there is a need to provide proper schemes to solve these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to adaptations of PDCCH monitoring and scheduled cells combination for multi-cell scheduling.

In one aspect, a method may involve an apparatus receiving a configuration of one or more search spaces for a DCI indicating a scheduling on a first cell in a second cell. The method may also involve the apparatus detecting the DCI indicating the scheduling on the first cell in the second cell according to the configuration. The method may further involve the apparatus determining not to monitor PDCCH candidates on an active DL bandwidth part (BWP) of the first cell.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a configuration of one or more search spaces for a DCI indicating a scheduling on a first cell in a second cell. The processor may also perform operations comprising detecting, via the transceiver, the DCI indicating the scheduling on the first cell in the second cell according to the configuration. The processor may further perform operations comprising determining not to monitor PDCCH candidates on an active DL BWP of the first cell.

In one aspect, a method may involve an apparatus receiving a configuration of one or more search spaces and a plurality of sets of cells for multi-cell scheduling DCI in a cell group. The method may also involve the apparatus detecting a DCI indicating a scheduling on one of the sets of cells in the cell group according to the configuration, wherein a scheduled cells combination in one set of cells is not included in another set of cells. The method may further involve the apparatus performing a physical downlink shared channel (PDSCH) reception or a physical uplink shared channel (PUSCH) transmission on at least one cell among the one of the sets of cells.

It is noteworthy that, although description provided herein may be in the context of certain radio access technologies, networks and network topologies such as Long-Term Evolution (LTE), LTE-Advanced, LTE-Advanced Pro, 5^{th} Generation (5G), New Radio (NR), Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of DCI reception corresponding to a plurality of cells in the current 5G NR framework.

FIG. 2 is a diagram depicting an example scenario of multi-cell scheduling with a single DCI in accordance with implementations of the present disclosure.

FIG. 3 is a diagram depicting an example scenario of a table for scheduled cells combinations in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to PDCCH monitoring and scheduled cells combination for multi-cell scheduling. According to the present disclosure, a number of possible solutions may be implemented separately or jointly. That is, although these possible solutions may be described below separately, two or more of these possible solutions may be implemented in one combination or another.

In 3^{rd} Generation Partnership Project (3GPP), a radio access network (e.g., 5G NR access network) may include a plurality of BSs (e.g., Next Generation Node-Bs (gNBs)) to communicate with a plurality of mobile stations referred as UEs. In the current 5G NR framework, one BS is operable to provide radio coverage to a specific geographical area using a plurality of cells forming a radio access network. The BS may support the operations of the plurality of cells, and each cell may be operable to provide services to at least one UE within its radio coverage. Specifically, each cell may provide services to serve one or more UEs within its radio coverage based on at least one DCI, where a radio coverage of one cell may overlap with another radio coverage of other cell(s). In one example, each cell may schedule a DL/UL resource to one UE within its radio coverage by one DCI for performing a DL/UL transmission. If the UE can support more than one cell (e.g., application in dual connectivity), the UE may receive more than one DCI for scheduling DL/UL transmissions with the more than one cells.

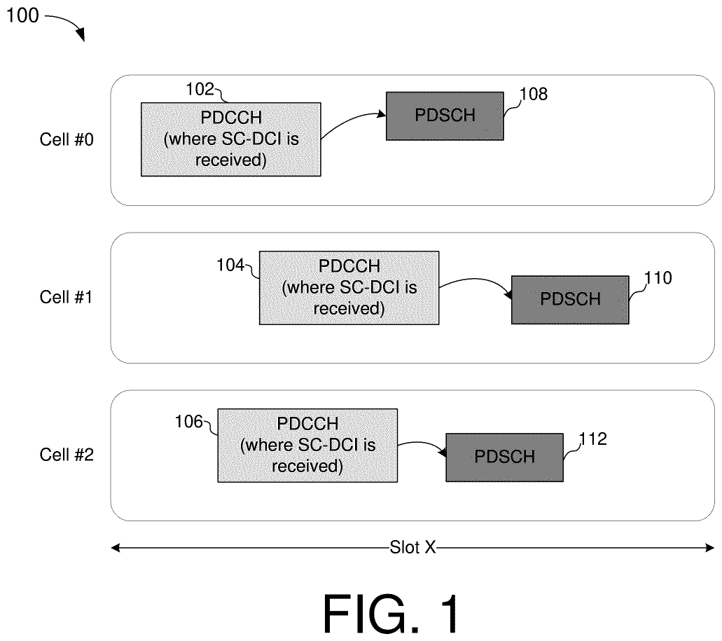

FIG. 1 illustrates an example scenario 100 of DCI reception corresponding to a plurality of cells in the current 5G NR framework. In scenario 100, at least one BS may serve a UE with three cells and provide three DCIs 102, 104 and 106. Each DCI 102/104/106 (also called a single-cell DCI (SC-DCI)) are received on the PDCCH of a respective cell. Specifically, the DCI 102 is utilized for a scheduling of a PDSCH reception 108 on a cell with ServCellIndex=0 (denoted as Cell #0) to the UE, the DCI 104 is utilized for a scheduling of a PDSCH reception 110 on a cell with ServCellIndex=1 (denoted as Cell #1) to the UE, and the DCI 106 is utilized for a scheduling of a PDSCH reception 112 on a cell with ServCellIndex=2 (denoted as Cell #2) to the UE. As that, the UE may communicate with these three cells and perform a PDSCH reception scheduled by the three DCIs 102, 104 and 106, respectively. Alternatively, each of the DCI 102, 104 and 106 may be utilized for a scheduling of a PUSCH transmission on the corresponding cell.

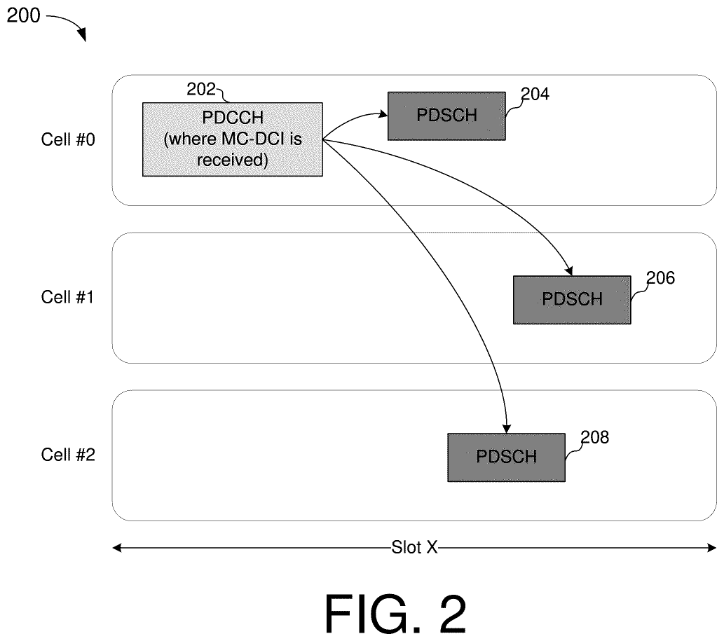

FIG. 2 illustrates an example scenario 200 of multi-cell scheduling with a single DCI in accordance with implementations of the present disclosure. In scenario 200, a multi-cell scheduling DCI 202 is received on the PDCCH of a cell with ServCellIndex=0 (denoted as Cell #0), which is also called the scheduling cell. Specifically, the multi-cell scheduling DCI 202 is utilized for scheduling of a PDSCH reception 204 on the cell with ServCellIndex=0 (denoted as Cell #0), a PDSCH reception 206 on the cell with ServCellIndex=1 (denoted as Cell #1) (also called a scheduled cell), and a PDSCH reception 208 on the cell with ServCellIndex=2 (denoted as Cell #0) (also called a scheduled cell). As that, the UE may communicate with these three cells and perform PDSCH receptions scheduled by the multi-cell scheduling DCI 202. Alternatively, the multi-cell scheduling DCI 202 may be utilized for a scheduling of a PUSCH transmission on each cell.

Under a first proposed scheme in accordance with the present disclosure, the UE does not expect to monitor PDCCH candidates on an active DL BWP of a secondary cell if the UE is configured to monitor PDCCH candidates for detection of DCI formats scheduling on that secondary cell in another serving cell. That is, the UE may determine not to monitor PDCCH candidates on the active DL BWP of a first cell in an event that a configuration of one or more search spaces for a DCI indicating a scheduling on the first cell is received in a second cell and the DCI is detected in the second cell according to the configuration. Accordingly, by applying this scheme of the present disclosure, PDCCH resource saving for the network (NW) side and blind decoding (BD) complexity and power saving for the UE side may be improved.

In some implementations, the DCI may be a multi-cell scheduling DCI.

In some implementations, the DCI may include a DCI format 0_3 for scheduling of a PUSCH transmission on the first cell among a plurality of cells.

In some implementations, the DCI may include a DCI format 1_3 for scheduling of a PDSCH reception on the first cell among a plurality of cells.

In some implementations, the configuration may be received via a radio resource control (RRC) signaling.

In some implementations, the detecting of the DCI may include monitoring PDCCH candidates for the one or more search spaces in the second cell.

In some implementations, the monitoring of PDCCH candidates may be performed only in the second cell.

Under a second proposed scheme in accordance with the present disclosure, when multiple sets of cells are configured for multi-cell scheduling, a scheduled cells combination in one set of cells can't be included in another set of cells. That is, from UE's perspective, the UE may receive a configuration of one or more search spaces and a plurality of sets of cells for multi-cell scheduling DCI in a cell group. Then, the UE may detect a DCI indicating a scheduling on one of the sets of cells in the cell group according to the configuration, wherein a scheduled cells combination in one set of cells is not included in another set of cells. The UE may perform a PDSCH reception or a PUSCH transmission on at least one cell among the one of the sets of cells. On the other hand, from NW's perspective, the BS may transmit a configuration of one or more search spaces and a plurality of sets of cells for multi-cell scheduling DCI to the UE in a scheduling cell, and then transmit a DCI indicating a scheduling on one of the sets of cells in the scheduling cell to the UE according to the configuration, with a condition that a scheduled cells combination in one set of cells is not included in another set of cells. Accordingly, by applying this scheme of the present disclosure, UE's operational complexity for multi-cell scheduling may be improved in terms of PDCCH candidates scattered through the time and/or frequency domain (instead of crammed together in the time and/or frequency domain).

In some implementations, a cell in one set of cells is not included in another set of cells.

In some implementations, the DCI may be a multi-cell scheduling DCI.

In some implementations, the DCI may include a DCI format 0_3 for scheduling of a PUSCH transmission on at least one cell among the one of the sets of cells.

In some implementations, the DCI may include a DCI format 1_3 for scheduling of a PDSCH reception on at least one cell among the one of the sets of cells.

In some implementations, the configuration may be received via an RRC signaling.

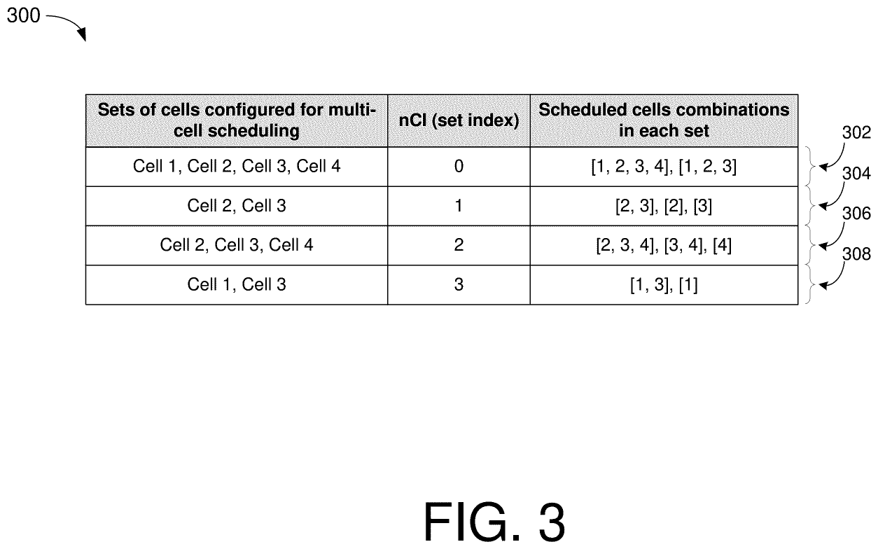

FIG. 3 illustrates an example scenario 300 of a table for scheduled cells combinations in accordance with implementations of the present disclosure. In scenario 300, a table is shown to depict the scheduled cells combinations for each set of cells when multiple sets of cells are configured for multi-cell scheduling. Specifically, the table may include multiple mappings, each indicates a respective set of scheduled cells for a multi-cell scheduling DCI and the corresponding scheduled cells combinations in each set. For instance, mapping 302 indicates that the scheduled cells combinations for the set of scheduled cells with a set index of 0 may include {cell 1, cell 2, cell 3, cell 4} and {cell 1, cell 2, cell 3}. Mapping 304 indicates that the scheduled cells combinations for the set of scheduled cells with a set index of 1 may include {cell 2, cell 3}, {cell 2}, and {cell 3}. Mapping 306 indicates that the scheduled cells combinations for the set of scheduled cells with a set index of 2 may include {cell 2, cell 3, cell 4}, {cell 3, cell 4}, and {cell 4}. Mapping 308 indicates that the scheduled cells combinations for the set of scheduled cells with a set index of 3 may include {cell 1, cell 3} and {cell 1}. It is noteworthy that a scheduled cells combination in one set of cells can't be included in another set of cells. Alternatively, the set-based multi-cell scheduling may be configured with another condition that a cell in one set of cells is not included in another set of cells, thereby contributing to the condition that a scheduled cells combination in one set of cells can't be included in another set of cells.

### Illustrative Implementations

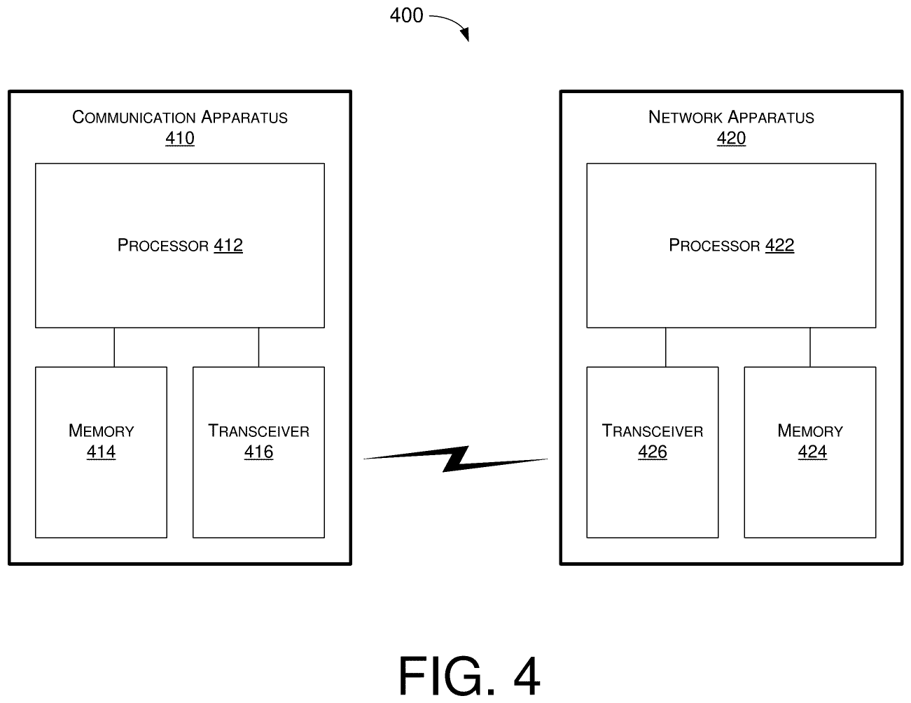

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to PDCCH monitoring and scheduled cells combination for multi-cell scheduling, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a base station, a small cell, a router or a gateway. For instance, network apparatus 420 may be implemented in an eNodeB in an LTE, LTE-Advanced or LTE-Advanced Pro network or in a gNB in a 5G, NR, IoT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including PDCCH monitoring and scheduled cells combination for multi-cell scheduling in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

According to some schemes of the present disclosure, processor 412 may receive, via transceiver 416, a configuration of one or more search spaces for a DCI indicating a scheduling on a first cell in a second cell. Then, processor 412 may detect, via transceiver 416, the DCI indicating the scheduling on the first cell in the second cell according to the configuration. Also, processor 412 may determine not to monitor.

PDCCH candidates on an active DL BWP of the first cell.

In some implementations, the DCI may be a multi-cell scheduling DCI.

In some implementations, the DCI may include a DCI format 0_3 for scheduling of a PUSCH transmission on the first cell among a plurality of cells.

In some implementations, the DCI may include a DCI format 1_3 for scheduling of a PDSCH reception on the first cell among a plurality of cells.

In some implementations, the configuration may be received via an RRC signaling.

In some implementations, the detecting of the DCI may include monitoring PDCCH candidates for the one or more search spaces in the second cell.

In some implementations, the monitoring of PDCCH candidates may be performed only in the second cell.

According to some schemes of the present disclosure, processor 412 may receive, via transceiver 416, a configuration of one or more search spaces and a plurality of sets of cells for multi-cell scheduling DCI in a cell group. Then, processor 412 may detect, via transceiver 416, a DCI indicating a scheduling on one of the sets of cells in the cell group according to the configuration, wherein a scheduled cells combination in one set of cells is not included in another set of cells. Processor 412 may further perform, via transceiver 416, a PDSCH reception or a PUSCH transmission on at least one cell among the one of the sets of cells. On the other hand, from NW's perspective, processor 422 of network apparatus 420 may transmit, via transceiver 426, the configuration of one or more search spaces and a plurality of sets of cells for multi-cell scheduling DCI to communication apparatus 410 in a cell group, and then transmit a DCI indicating a scheduling on one of the sets of cells in the cell group to the UE according to the configuration, with a condition that a scheduled cells combination in one set of cells is not included in another set of cells.

In some implementations, a cell in one set of cells may not be included in another set of cells.

In some implementations, the DCI may be a multi-cell scheduling DCI.

In some implementations, the DCI may include a DCI format 0_3 for scheduling of the PUSCH transmission on the at least one cell among the one of the sets of cells.

In some implementations, the DCI may include a DCI format 1_3 for scheduling of the PDSCH reception on the at least one cell among the one of the sets of cells.

In some implementations, the configuration may be received via an RRC signaling.

### Illustrative Processes

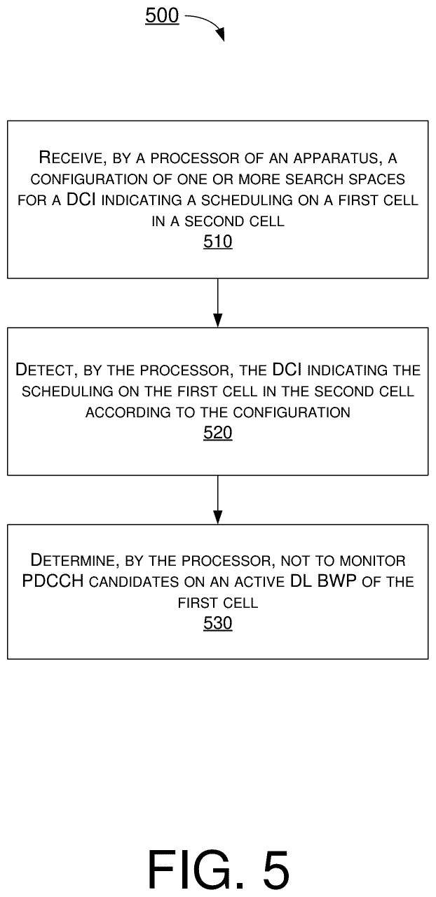

FIG. 5 illustrates an example process 500 in accordance with an implementation of the present disclosure. Process 500 may be an example implementation of above scenarios/schemes, whether partially or completely, with respect to PDCCH monitoring for multi-cell scheduling. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of communication apparatus 410 receiving, via transceiver 416, a configuration of one or more search spaces for a DCI indicating a scheduling on a first cell in a second cell. Process 500 may proceed from 510 to 520.

At 520, process 500 may involve processor 412 detecting, via transceiver 416, the DCI indicating the scheduling on the first cell in the second cell according to the configuration. Process 500 may proceed from 520 to 530.

At 530, process 500 may involve processor 412 determining not to monitor PDCCH candidates on an active DL BWP of the first cell.

In some implementations, the DCI may be a multi-cell scheduling DCI.

In some implementations, the DCI may include a DCI format 0_3 for scheduling of a PUSCH transmission on the first cell among a plurality of cells.

In some implementations, the DCI may include a DCI format 1_3 for scheduling of a PDSCH reception on the first cell among a plurality of cells.

In some implementations, the configuration may be received via an RRC signaling.

In some implementations, the detecting of the DCI may include monitoring PDCCH candidates for the one or more search spaces in the second cell.

In some implementations, the monitoring of PDCCH candidates may be performed only in the second cell.

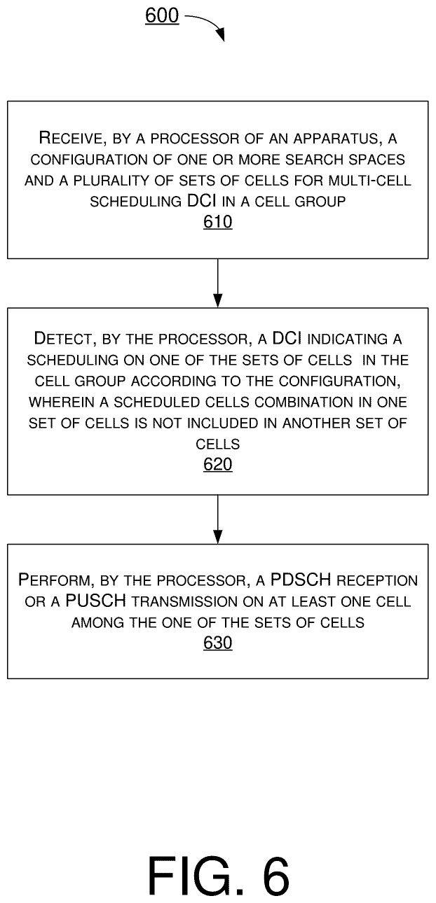

FIG. 6 illustrates an example process 600 in accordance with an implementation of the present disclosure. Process 600 may be an example implementation of above scenarios/schemes, whether partially or completely, with respect to scheduled cells combination for multi-cell scheduling. Process 600 may represent an aspect of implementation of features of communication apparatus 410. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 410 or any suitable UE or machine type devices. Solely for illustrative purposes and without limitation, process 600 is described below in the context of communication apparatus 410. Process 600 may begin at block 610.

At 610, process 600 may involve processor 412 of communication apparatus 410 receiving, via transceiver 416, a configuration of one or more search spaces and a plurality of sets of cells for multi-cell scheduling DCI in a cell group. Process 600 may proceed from 610 to 620.

At 620, process 600 may involve processor 412 detecting, via transceiver 416, a DCI indicating a scheduling on one of the sets of cells in the cell group according to the configuration, wherein a scheduled cells combination in one set of cells is not included in another set of cells. Process 600 may proceed from 620 to 630.

At 630, process 600 may involve processor 412 performing, via transceiver 416, a PDSCH reception or a PUSCH transmission on at least one cell among the one of the sets of cells.

In some implementations, a cell in one set of cells may not be included in another set of cells.

In some implementations, the DCI may be a multi-cell scheduling DCI.

In some implementations, the DCI may include a DCI format 0_3 for scheduling of the PUSCH transmission on the at least one cell among the one of the sets of cells.

In some implementations, the DCI may include a DCI format 1_3 for scheduling of the PDSCH reception on the at least one cell among the one of the sets of cells.

In some implementations, the configuration may be received via an RRC signaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a configuration of one or more search spaces for a downlink control information (DCI) indicating a scheduling on a first cell in a second cell;
detecting, by the processor, the DCI indicating the scheduling on the first cell in the second cell according to the configuration; and
determining, by the processor, not to monitor physical downlink control channel (PDCCH) candidates on an active downlink (DL) bandwidth part (BWP) of the first cell.

2. The method of claim 1, wherein the DCI is a multi-cell scheduling DCI.

3. The method of claim 2, wherein the DCI comprises a DCI format 0_3 for scheduling of a physical uplink shared channel (PUSCH) transmission on the first cell among a plurality of cells.

4. The method of claim 2, wherein the DCI comprises a DCI format 1_3 for scheduling of a physical downlink shared channel (PDSCH) reception on the first cell among a plurality of cells.

5. The method of claim 1, wherein the configuration is received via a radio resource control (RRC) signaling.

6. The method of claim 1, wherein the detecting of the DCI comprises monitoring PDCCH candidates for the one or more search spaces in the second cell.

7. The method of claim 1, wherein the monitoring of PDCCH candidates is performed only in the second cell.

8. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a configuration of one or more search spaces for a downlink control information (DCI) indicating a scheduling on a first cell in a second cell;
detecting, via the transceiver, the DCI indicating the scheduling on the first cell in the second cell according to the configuration; and
determining not to monitor physical downlink control channel (PDCCH) candidates on an active downlink (DL) bandwidth part (BWP) of the first cell.

9. The apparatus of claim 8, wherein the DCI is a multi-cell scheduling DCI.

10. The apparatus of claim 9, wherein the DCI comprises a DCI format 0_3 for scheduling of a physical uplink shared channel (PUSCH) transmission on the first cell among a plurality of cells.

11. The apparatus of claim 9, wherein the DCI comprises a DCI format 1_3 for scheduling of a physical downlink shared channel (PDSCH) reception on the first cell among a plurality of cells.

12. The apparatus of claim 8, wherein the configuration is received via a radio resource control (RRC) signaling.

13. The apparatus of claim 8, wherein the detecting of the DCI comprises monitoring PDCCH candidates for the one or more search spaces in the second cell.

14. The apparatus of claim 8, wherein the monitoring of PDCCH candidates is performed only in the second cell.

15. A method, comprising:
receiving, by a processor of an apparatus, a configuration of one or more search spaces and a plurality of sets of cells for multi-cell scheduling downlink control information (DCI) in a cell group;
detecting, by the processor, a DCI indicating a scheduling on one of the sets of cells in the cell group according to the configuration, wherein a scheduled cells combination in one set of cells is not included in another set of cells; and
performing, by the processor, a physical downlink shared channel (PDSCH) reception or a physical uplink shared channel (PUSCH) transmission on at least one cell among the one of the sets of cells.

16. The method of claim 15, wherein a cell in one set of cells is not included in another set of cells.

17. The method of claim 15, wherein the DCI is a multi-cell scheduling DCI.

18. The method of claim 17, wherein the DCI comprises a DCI format 0_3 for scheduling of the PUSCH transmission on the at least one cell among the one of the sets of cells.

19. The method of claim 17, wherein the DCI comprises a DCI format 1_3 for scheduling of the PDSCH reception on the at least one cell among the one of the sets of cells.

20. The method of claim 15, wherein the configuration is received via a radio resource control (RRC) signaling.
